(19) United States
(12) Patent Application Publication
(10) Pub. No.: US 2006/0026878 A1
(43) Pub. Date: Feb. 9, 2006

(54) Multiple key identifying and labeling invention

(76) Inventor: Randy Slater, Palm Springs, CA (US)

Correspondence Address: BUHLER & ASSOCIATES;SUITE 100, 1101 CALIFORNIA AVENUE, CORONA, CA, 92881, US

(21) Appl. No.: 10/911,362

(22) Filed: Aug. 4, 2004

(51) Int. Cl. G09F 15/00

(52) U.S. Cl. 40/634

(57) ABSTRACT

The invention is used to provide identification to items that may have a similar appearance. Items such as keys all appear similar, and often the only way to ensure the correct key is being used is to try one or multiple keys in a lock until the correct key is located. This invention consists of a sheet of adhesive backed, pre-printed labels that can be individually removed and placed onto keys to identify the function of the key. Labels may include text such as car, boat, home, office or other text that when placed onto a key makes the correct key easy to identify.

### FIELD OF THE INVENTION

The present invention relates generally to a labeling product. More specifically; the invention consists of a sheet of adhesive backed pre-printed labels that can be individually removed and placed onto keys or items that may have a similar appearance. The sheet may also include blank or partially blank labels that the user can write on to identify other items or location named.

### BACKGROUND OF THE INVENTION

Most people carry a number of keys with them to open doors, mail boxes, or operate vehicles. The average person may carry two or more keys for their house, two or more car keys, for the ignition and the car door, and a number of work keys. A person may also carry keys for locks or a neighbor or relative's house. Often these keys may appear similar. This is especially true when the person has multiple house keys that are the from the same lock manufacturer. Several key identification inventions have been made that wrap around, keys or other items to provide a unique marking to each key so a person can more simply identify the use for the key without testing the key or memorizing the unique shape of the key. Other companies make keys that are different colors. One of the major problems with these inventions requires a person to memorize the shape color or size of the key to identify the use for the key. It is often impossible to determine the use of the same or similar shaped keys.

U.S. Pat. No. 4,305,267 issued December 1981 to Nish et al discloses a pocketed or recessed key cover. This invention covers the head of a key on one side, and wraps around the edge of the key. The cover has a rectangular recess to allow keys with various head configurations to fit within the recess. While this invention provides the ability to identify different keys, it adds additional thickness to each key in addition to making each key larger in head size.

U.S. Pat. No. 2,138,309 issued Nov. 29, 1938 to J. T. Stevenson, U.S. Pat. No. 4,403,487 issued Sep. 13, 1983 to Marty, U.S. Pat. No. 4,768,362 issued Sep. 6, 1988 to Schmalz Jr. and U.S. Pat. No. 1,966,550 issued Jul. 17, 1934 to H. L. Handy disclose a preformed key cover that a key is inserted into. The cover consists of a flexible body that the user wraps around or inserts the key through. The cover adds additional protection and cushion to every key. In most cases, the identification is the color or material of the cover. The covers can also be removed and installed on other keys. While these inventions provide a limited ability to identify different keys, they add additional thickness to each key and make the head of each key larger. A person borrowing keys may have no way to identify the use of a key if the only identifier of the key is color.

U.S. Pat. No. 5,038,590 issued Aug. 13, 1991 to Sawyer et al, U.S. Pat. No. 3,225,478 issued Dec. 28, 1965 to R. H. Rohmer U.S. Pat. No. 2,982,041 issued May 2, 1961 issued to J. E. Kent and U.S. Pat. No. 1,837,114 issued Dec. 15, 1931 to J. Cicourel each disclose a malleable or bendable key identifying invention. These inventions begin as a flat printed metal blank that may have printing on one side that identifies each ring. The user inserts a key onto the metal blank and then bends the metal blank around and over the key. The blank may be removed and installed on another key in the future. While these inventions provide a limited ability to identify different keys, they add potentially sharp edges to smooth keys, add additional thickness to each key and make the head of each key larger.

Some product are currently available for naming circuit breakers or fuse boxes. Labels for circuit breakers may include “Bathroom”, “Bedroom” and “Kitchen”. Other labeling products are also available for labeling moving boxes. Moving and stored box labels may also include “Bathroom”, “Bedroom”, “Toys”, “Dishes” and “Kitchen”. These box labels may also include information regarding the date of storage and or quantity. While these labels can be used to identify circuit breakers and boxes, they are not intended to be integrated onto a key.

Another method of identifying a key is engraving onto the surface of each key. While this method solves the problem of identifying the key, it is not cost effective, and requires special equipment and is quite time consuming to perform to each key. Many key identifying devices are available, but are not integrated into the key when applied. Another method that has been used is to attach a separate tag to each key that identifies the key. This adds additional volume to a key ring, and the additional volume may make using the keys more difficult especially when the key is inserted into the ignition of a car, or into a small space. Adding thickness to the head of a key limits and substantially reduces the number of keys that can be installed onto a key ring. The additional thickness also restricts free movement of the keys on the key ring.

What is needed is a simple device that allows a person to quickly and easily identify the key they are looking for without memorizing the shape color or size of the key to identify the use for the key. In another scenario, a wife may borrow her husbands keys and easily and quickly identify the “tool shed key”. This device would be easy to install on a key, semi-permanent, cost effective and would add a minimal thickness to the key. The proposed invention satisfies these requirements.

### BRIEF SUMMARY OF THE INVENTION

It is an objective of the present invention to provide an identifying product for keys or other items that may appear similar. This invention is superior to other devices that are available for a number of reasons. Most currently available products add significant thickness to the key, are difficult to use, are not integrated into the key or require expensive equipment to mark the keys. The invention provides a simple cost effective solution to this problem.

One feature of the invention is to provide a sheet of pre-printed labels that provides the convenience of removing the labels that are required and placing them onto each key. The labels would include common descriptions that most users would require like “SPARE1”, “STORAGE2” or “CABINET” the labeling may be even more descriptive such as “FRONT1”, “BIKE”, “GUN”, or “DESK” to identify a specific use for each key. The labels may be made small enough that multiple labels can be used on a key, or different labels can be placed on the front and back of each key.

Another feature of the invention is to provide abrasion resistance or coating to the label(s) so the identification on the label is not easily removed or rubbed off from daily use or as multiple keys rub against each other.

Another feature of the invention is the ability to cut the label to match the size of a key or to make the label allow clearance around openings or holes in the key.

Another feature of the invention is to provide the pre labeled or markable label in a thin configuration that add a minimal additional thickness to each key.

Another feature of the invention is to provide the label with an adhesive backing so the user can place the label onto a key. In another embodiment the invention can be fabricated without an adhesive backing, and a glue pack could be provided to allow the user to glue the label onto a key.

Another feature of the invention is to provide the labels in a variety of colors so a user can associate each color with a function. The colors can be single or multiple colors, as well as the color can be a glow in the dark printing that allows the identity of the key to be determined in dark or low light conditions.

The need for such a product can be found in a number of places where people carry multiple objects that appear the same. Keys are just one example of an object that appear similar. Other examples include pill bottles that could include markings for morning pill and evening pill. Still another application could be labels on toothbrushes in a family where a package of identical toothbrushes are purchased. Each toothbrush could easily be labeled as mom, dad, boy1, boy2, girl1, girl2 etc.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a view of a sheet of labels.

FIG. 2 is a view of one individual label.

FIG. 3 is a view of one embodiment showing the construction of the label.

FIG. 4 is a view of a label attached to a key.

### DETAILED DESCRIPTION OF THE INVENTION

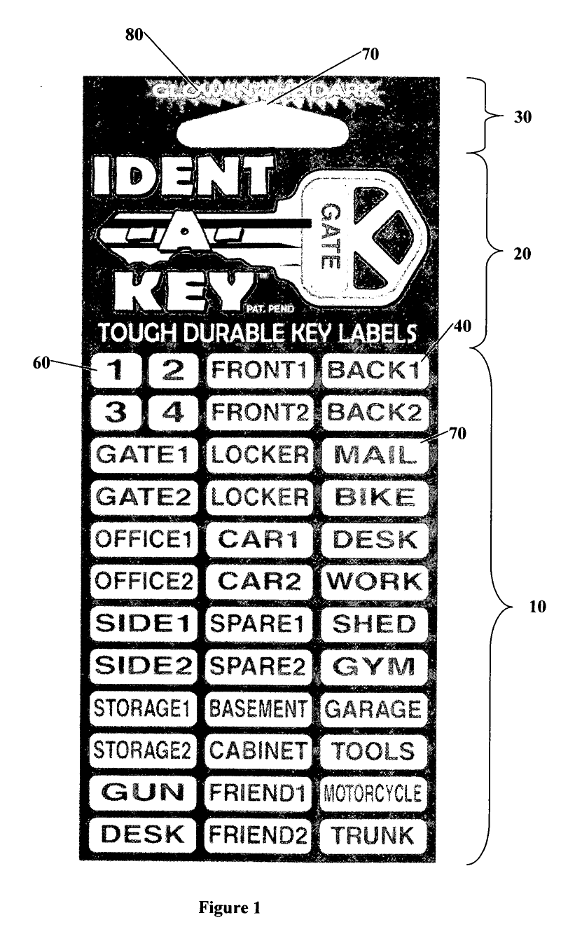

Referring first to FIG. 1, that shows a sheet of the labels as they are available in the preferred embodiment. The sheet consists of multiple labels where each label is printed to identify a specific use for each key. Each label can also be sold individually. In the preferred embodiment of distributing the labels, the labels can be manufactured on the sheet shown. The sheet may consist of three separate parts. The first part 10, is the labels, the second part 20 is the product identification section, and the third part 30 is the mounting or hanging section. While this embodiment shows the product presented in a sellable format, the configuration of the product can be fabricated in a variety of methods including but not limited to bagged, and located on both sides of a sheet. The labels can be grouped to make it easier to locate keys for specific purposes. For example, keys that are intended for use on a house can be grouped together. Keys for a house like item 40 that shows labels FRONT1, FRONT2, BACK1, BACK2. Other keys may be grouped to identify items that may be located in or around a house, like item 50 that show labels MAIL, BIKE, DESK, etc. Other labels may include just numbers as shown by item 60, or letters that a user can combine to identify other keys.

The middle portion of the distribution packaging 20 provides identification of the product and invention. In this figure, the middle section shows a picture of the label on a key. This figure also shows the name of the invention “IDENT-A-KEY”. Other information regarding how to apply a label can be included in this portion of the distribution packaging.

The top portion of the distribution packaging 30 shows some additional features of the product 80 that indicates the product can “GLOW IN THE DARK”. The top portion of the distribution packaging in this embodiment includes a hanger hole 70 that allows the product to hang from a hook in a vertical orientation. This figure shows a triangular shaped hanger, that allows the packaged product to hang on a single, multiple or flat hook. The packaged product may include multiple holes for hanging. The label(s) can be sold in a self display unit or sold wholesale by the sheet.

FIG. 1 shows a full sheet of various labels, but a sheet may have all the same label such as “Front”. A sheet with all the same label may be used by a locksmith where after a key is copied, the locksmith can remove one label from the sheet and apply the label to the key that was copied.

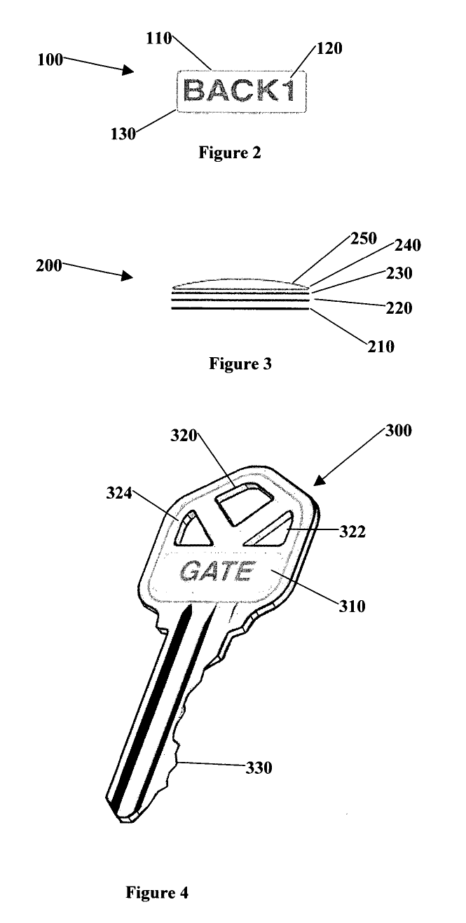

FIG. 2 is a view of one individual label. In this figure, the label is shown with rounded edges, but the label can be kiss cut square, with rounded corners or any variety of patterns for the sides and corners. When the label is kiss cut the label is cut, but the release liner remains uncut. Each label 100 can be kiss cut into the sheet, or the user can cut each label out of the sheet using scissor or a knife. In the preferred embodiment, the corner(s) 130 are rounded to reduce the possibility that the label will peel off. In the preferred embodiment, the edges 110 of the labels are straight, and perpendicular in orientation. The labels may all consist of the same shape, or the labels may consist of a variety of different shapes and sizes to conform to the geometry of the key. The geometry may be rectangular, square, round, triangular, or other multi-sided, or a combination of round and square sides. The label may include preprinted text 110. Alternatively, the label may include, one or more labels that are all or partially blank so a user can write onto the label. Labels can be manufactured in a variety of sizes.

FIG. 3 is a view of one embodiment showing the construction of a label 200. In the preferred embodiment, the labels are manufactured with a lower level release liner 210. The release liner, consist of a paper or similar backing that one or more labels can be removed from. The label may include, an adhesive 220 that holds the label(s) onto the release liner, also provide a secure bond to the key. The adhesive is used to hold the label onto each key, and the adhesive bond to the key may or may not become stronger the longer the label is held onto a key. In another embodiment, the label may not include an adhesive, but a separate adhesive is used to used to bond the label to the key. The separate adhesive may include epoxies, cyno-acrylate, double sided adhesive tapes or other similar adhesive that will hold the label onto a key. Another embodiment may include a two part adhesive where the first part is included in the label, and the second part is placed onto the surface of the key. When the label is placed onto the key, the two parts combine to bond the label onto the key. The mid level of the label may be pre-printed with text 230. If the label material is made from clear material such as Mylar, PVC, ABS, Lexan, epoxy, polyurethane or other similar material, the printing may be placed between the adhesive layer and the label. If the label material 240 is made from a non-transparent material such as paper or metal, the printing may be placed between the label material and the protective cover. The printing may be one two, or multiple colors or a variety of patterns. The printing may glow in the dark to help identify a key in darkness. The text on the label may be stamped through a paper, Mylar, metal or other material where the text is visible through the material removed from the label. A lop level protective layer 250 may optionally be placed over the label. The protective material may be printed or flowed onto or over the label. The protective layer can be made from a variety of materials including but not limited to Mylar, PVC, ABS, Lexan, epoxy, polyurethane or other similar material. In addition to blank labels the sheet may also include blank protective covers so the user can write on a blank label, place the label on a key, and then place a blank protective cover over the custom label. In an alternative embodiment the label material may be stamped, embossed, etched, or laser-cut out of metal or plastic. In this alternative embodiment, the protective coating may not be used.

FIG. 4 is a view of a label attached to a key. A key 300 is shown with a label 310 applied to one side of the key. In this figure, the key includes a hole 320 where the key can be held on a key ring. This figure shows additional holes located in the key 322 and 324. The key includes multiple teeth 330 that engage in the lock to open or lock a door or lock. In this figure, a rectangular label is shown. The user may purchase two sets of labels, and place identical labels on each side of the key to be able to identify the key when the key is viewed from either side.

Thus, specific embodiments and applications for the key identification invention have been disclosed. It should be apparent, however, to those skilled in the art that many more modifications besides those described are possible without departing from the inventive concepts herein. For example, the invention may include an elongated narrow label that can be placed on the side of a key so the use of the key can be identified when viewed by the side of the key. The inventive subject matter, therefore, is not to be restricted except in the spirit of the appended claims.

1. A labeling system for a key comprising:
a sheet comprises a first level that temporarily retains at least one printed label, wherein the first level includes printed instructional information and at least one hole for hanging the sheet for sale,
a second level comprising adhesive that at least temporarily hold the adhesive level to the first level,
a third level that exists on top of the second level and includes printing that identifies the at least one label for a specific use,
a fourth level that exists on top of the second and third level to protective the printing on the third level wherein;
at least one label is removed from the sheet and adhered to a key to identify the key for the specific use.

2. The key labeling system for a key from claim 1 wherein the first level is a release liner.

3. (canceled)

4. (canceled)

5. The key labeling system for a key from claim 1 wherein the printing on the third level is made to the underside of the fourth level.

6. The key labeling system for a key from claim 1 wherein the printing is more than one color.

7. The key labeling system for a key from claim 1 wherein the background can glow in the dark.

8. The key labeling system for a key from claim 1 wherein the printing is at least semi-transparent or opaque.

9. The key labeling system for a key from claim 1 wherein the sheet contains a single or multiple labels where only the single or multiple labels are kiss cut from the lower level.

10. (canceled)

11. The key labeling system for a key from claim 1 wherein the sheet is made from metal, Mylar, PVC or ABS.

12. The key labeling system for a key from claim 1 wherein the top level is made from epoxy or Mylar.

13. The key labeling system for a key from claim 1 that further includes a two part bonding agent where one part is the adhesive from the second level included with the label, and a second part is applied either to the back of the label prior to attaching the label to a key, or onto a key prior to placing the label onto the key.

14-20. (canceled)
